(19) United States
(12) Patent Application Publication
(10) Pub. No.: US 2025/0320956 A1
(43) Pub. Date: Oct. 16, 2025

(54) LIFTING TRIPOD

(71) Applicant: TILTA INC., Burbank, CA (US)

(72) Inventors: Weihan SHE, Shenzhen (CN); Wenping ZENG, Shenzhen (CN); Kefeng ZHOU, Shenzhen (CN)

(21) Appl. No.: 19/173,080

(22) Filed: Apr. 8, 2025

(30) Foreign Application Priority Data
Apr. 11, 2024 (CN) 2024207477580

(51) Int. Cl. F16M 11/32; F16B 7/14

(52) U.S. Cl. CPC F16M 11/32; F16B 7/1454

(57) ABSTRACT

The present disclosure discloses a tripod includes: a first section, a second section, a third section, and a synchronized locking mechanism. The first and the third sections are movably connected relative to the locking mechanism, while the second section is fixedly secured to the mechanism, enabling controlled relative motion between the first and the third sections. The locking mechanism integrates a first locking assembly, a connecting assembly, and a second locking assembly.

### CROSS-REFERENCE TO RELATED APPLICATIONS

The present application for patent claims priority to and the benefit of pending Chinese Application No. 2024207477580, filed Apr. 11, 2024, and hereby expressly incorporated by reference herein as if fully set forth below in its entirety and for all applicable purposes.

### TECHNICAL FIELD

The present disclosure pertains to photographic auxiliary equipment, specifically to a lifting tripod.

### Introduction

In photography, to assist photographers in achieving desired effects, auxiliary equipment such as tripods is commonly used. During use, a camera is mounted on a tripod head. Photographers often need to shoot at different heights depending on composition requirements. Existing tripod products typically add lifting structures to each leg for telescoping purposes. However, most existing tripod lifting structures control the extension of a single telescoping section through a locking structure provided on each leg's telescoping section, resulting in cumbersome tripod lifting operations.

### BRIEF SUMMARY

The present disclosure introduces a lifting tripod that enables one-touch extension and retraction for convenient operation.

The technical solution of the present disclosure is as follows:

The present disclosure provides a lifting tripod including:
a first section;
a second section movably connected to the first section;
a third section movably connected to the second section;
a locking mechanism including a first locking assembly, a connecting assembly, and a second locking assembly; the first locking assembly is mounted atop the second section and the second locking assembly is mounted on the second section at bottom; the first locking assembly and the second locking assembly are connected through the connecting assembly; and wherein the first locking assembly enables locking or releasing between the first and the second sections, and the second locking assembly enables locking or releasing between the second and the third sections.

### BRIEF DESCRIPTION OF THE DRAWINGS

FIG. 1 is a diagram illustrating an isometric view of a tripod in a tightened state according to some aspects of the disclosure.

FIG. 2 is a diagram illustrating an isometric view of a support body in a retracted state according to some aspects of the disclosure.

FIG. 3 is a diagram illustrating an isometric view of the support body in an extended state according to some aspects of the disclosure.

FIG. 4 is a diagram illustrating a locking mechanism according to some aspects of the disclosure.

FIG. 5 is a diagram illustrating a partially enlarged view of a section A in FIG. 4.

FIG. 6 is a diagram illustrating a partially enlarged view of a section B in FIG. 4.

FIG. 7 is a diagram of a first mounting sleeve according to some aspects of the disclosure.

FIG. 8 is a diagram of a pressing member according to some aspects of the disclosure.

FIG. 9 is a diagram of a locking portion according to some aspects of the disclosure.

FIG. 10 is a diagram of a first regulating part and a second regulating part according to some aspects of the disclosure.

FIG. 11 is a diagram illustrating a cross-sectional diagram of the support body according to some aspects of the disclosure.

### REFERENCE NUMBERS

100. support body, 1. first section, 2. second section, 3. third section, 4. locking mechanism.
41. first locking assembly, 411. first mounting sleeve, 4111. movable shaft hole, 4112. fixed shaft hole, 4113. notch groove, 412. locking member, 4121. locking wrench, 4122. connecting rod, 4123. rotating shaft, 4124. eccentric rotating part, 413. pressing member, 4131. pressing groove, 414. first regulating part, 4141. first inclined surface, 415. second regulating part, 4151. second inclined surface, 4152. third inclined surface, 416. third regulating part, 4161. fourth inclined surface, 4162. first connecting part, 4163. second connecting part, 4164. movable groove.
42. connecting assembly, 421. connector, 422. movable rod, 423. connecting return spring, 424. nut.
43. second locking assembly, 431. second mounting sleeve, 432. fourth regulating part, 4321. fifth inclined surface, 433. fifth regulating part, 4331. sixth inclined surface.
44. locking sleeve.

### DETAILED DESCRIPTION

To clarify the objectives, technical solutions, and aspects of the present disclosure, the following provides a detailed description with reference to the drawings and examples. The specific examples described herein are exemplary and do not limit the scope of the present disclosure.

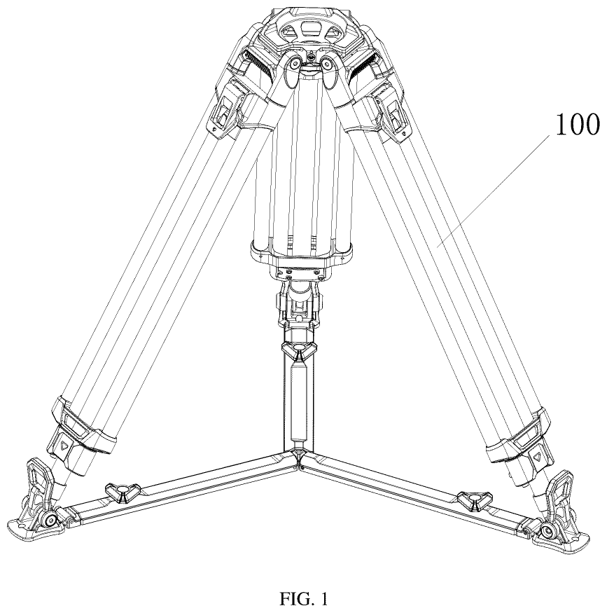

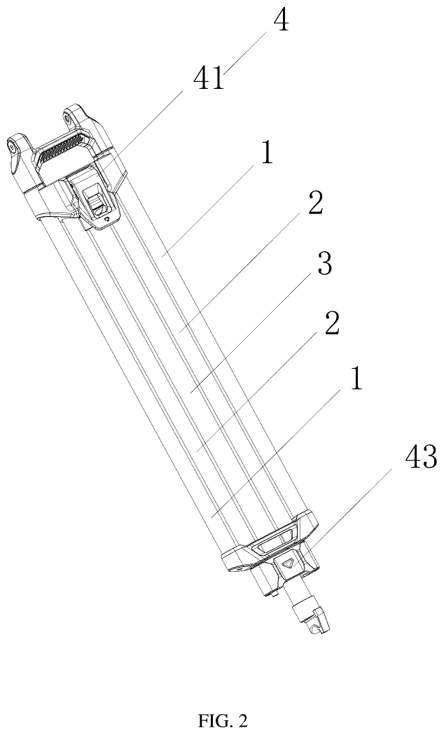

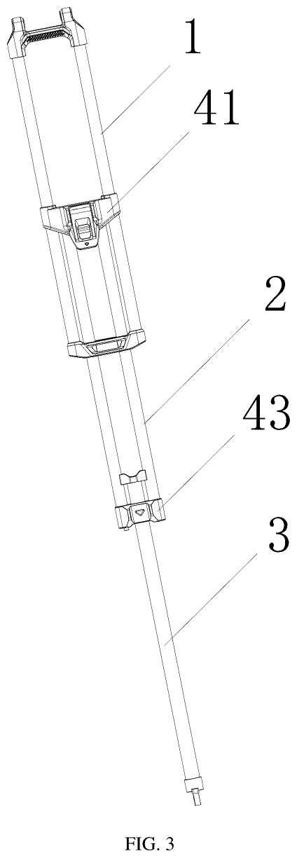

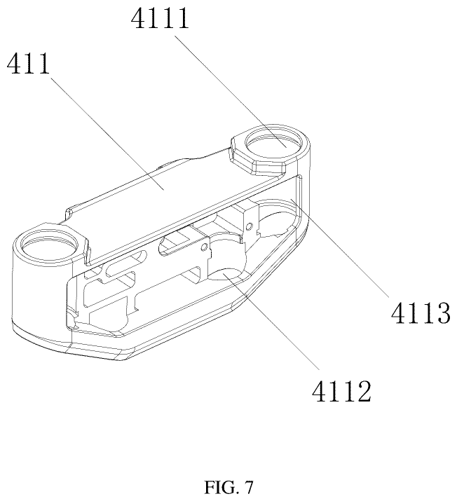

As shown in FIGS. 1-10, the disclosure provides an adjustable tripod including three support bodies 100 interconnected to form a triangular structure. Each support body 100 includes: a first section 1; a second section 2 movably connected to the first section 1; a third section 3 movably connected to the second section 2; and a locking mechanism 4 that includes a first locking assembly 41, a connecting assembly 42, and a second locking assembly 43.

The first locking assembly 41 is disposed at the top of the second section 2, and the second locking assembly 43 is disposed at the bottom of the second section 2. The first and second locking assemblies 41 and 43 are interconnected via the connecting assembly 42. The first locking assembly 41 controls the connection between the first section 1 and the second section 2, while the second locking assembly 43 controls the connection between the second section 2 and the third section 3.

The first locking assembly 41 and the second locking assembly 43 are connected through the connecting assembly 42 to enable simultaneous locking and releasing. During operation, activating the first locking assembly 41 triggers the entire locking mechanism 4, allowing one-touch extension or retraction of the tripod. This configuration simplifies operation and reduces user effort.

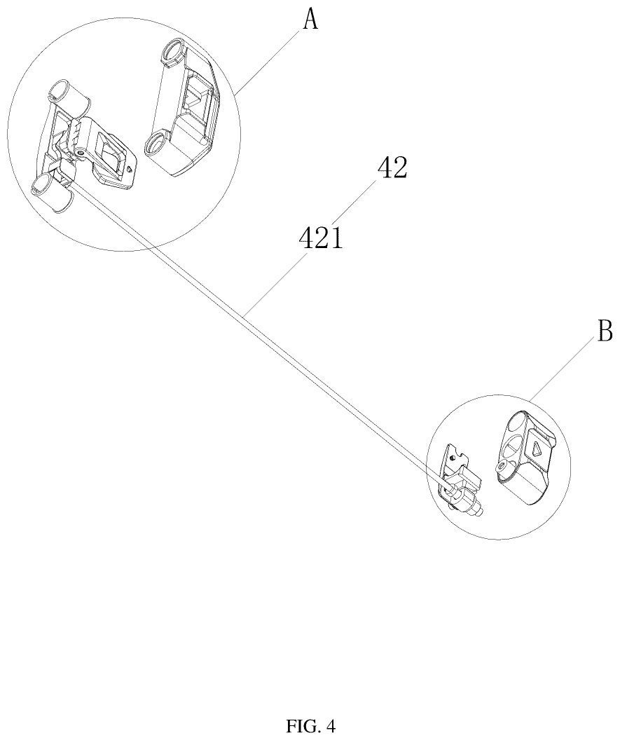

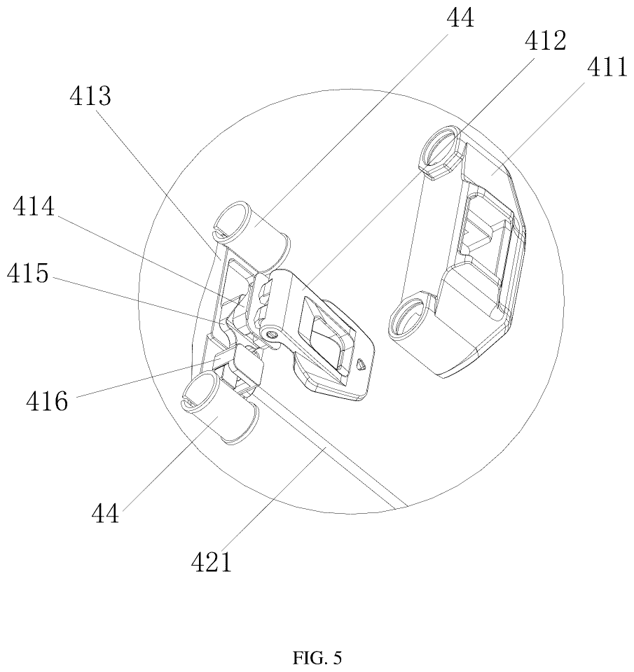

Furthermore, as shown in FIGS. 4-5, the first locking assembly 41 includes a first mounting sleeve 411, a locking member 412, and a pressing member 413. The first mounting sleeve 411 is positioned at the top of the second section 2, with the first section 1 movably connected to the first mounting sleeve 411. The locking member 412 and pressing member 413 are coupled such that the locking member 412 drives the pressing member 413 to engage (in a first position) or disengage (in a second position) the first section 1 by moving relative to the first mounting sleeve 411.

Furthermore, as shown in FIGS. 4-5, the first locking assembly 41 further includes a first regulating part 414, a second regulating part 415, and a third regulating part 416. The locking member 412 incorporates a locking wrench 4121 and a connecting rod 4122. The first regulating part 414 and the second regulating part 415 are slidably mounted on the connecting rod 4122, with the second regulating part 415 cooperating with both the first regulating part 414 and the third regulating part 416 on both ends, respectively. The third regulating part 416 connects to the connecting assembly 42. Actuating the locking wrench 4121 displaces the second regulating part 415 and the third regulating part 416 via the first regulating part 414, thereby moving the connecting assembly 42 and activating the second locking assembly 43 to lock or release the third section 3. This flexible arrangement enables rapid, low-effort adjustment of the tripod.

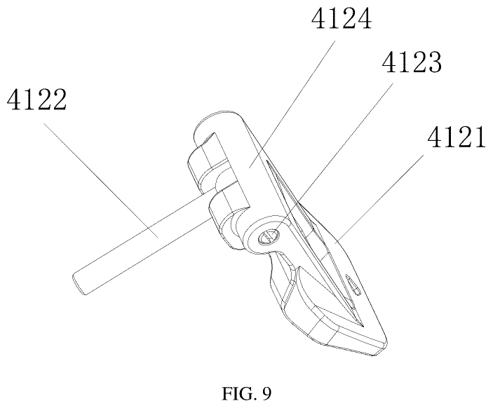

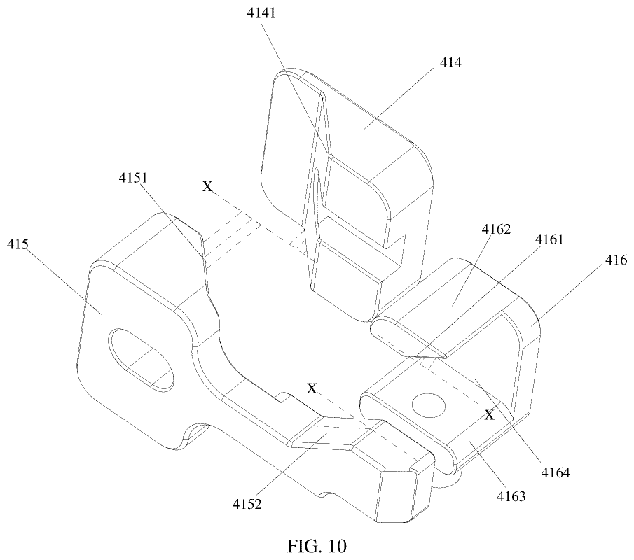

In some aspects, as shown in FIGS. 9-10, the first adjusting member 414 includes a first inclined surface 4141 (e.g., a first sloped surface). One end of the second adjusting member 415 features a second inclined surface 4151 (e.g., a second sloped surface) that cooperates with the first inclined surface 4141, while the other end has a third inclined surface 4152 (e.g., a third sloped surface). The third adjusting member 416 includes a fourth inclined surface 4161 (e.g., a fourth sloped surface) that engages with the third inclined surface 4152. The interaction between the first inclined surface 4141 and the second inclined surface 4151 drives the second adjusting member 415 to move along the longitudinal direction of the first mounting sleeve 411, causing the third inclined surface 4152 to engage with the fourth inclined surface 4161 of the third adjusting member 416. This movement prompts the connecting assembly 42 to move along the height direction of the second section 2, thereby actuating the second locking assembly 43 to lock or release the third section 3. In the present disclosure, when the eccentric rotating part 4124 rotates and moves toward the first mounting sleeve 411, it sequentially pushes the second adjusting member 415 to move right and the third adjusting member 416 to move upwards through the interaction of inclined surfaces. As shown in FIG. 10, in the disclosure, X represents an auxiliary line parallel to the longitudinal direction of the second adjusting member 415. The first inclined surface 4141 and the second inclined surface 4151 are inclined horizontally relative to the auxiliary reference line X, prompting the second adjusting member 415 to move horizontally. The third inclined surface 4152 and the fourth inclined surface 4161 are inclined vertically relative to the auxiliary reference line X, prompting the third adjusting member 416 to move vertically. This mechanism converts the horizontal movement of the first adjusting member 414 into the vertical movement of the third adjusting member 416, facilitating the linkage between the first locking assembly 41 and the second locking assembly 43.

In summary, the first inclined surface 4141, the second inclined surface 4151, the third inclined surface 4152, and the fourth inclined surface 4161 are all inclined along the longitudinal direction of the second adjusting member 415.

Furthermore, as shown in FIG. 10, the third adjusting member 416 includes a first connecting part 4162 and a second connecting part 4163. A movable groove 4164 (e.g., a slot) is formed between the first connecting part 4162 and the second connecting part 4163. The end of the second adjusting member 415 featuring the third inclined surface 4152 is movably disposed within the movable groove 4164. The fourth inclined surface 4161 is located on the side wall of the first connecting part 4162 facing the movable groove 4164. The second connecting part 4163 is connected to the connecting assembly 42.

Furthermore, as shown in FIG. 9, the locking member 412 includes a rotating shaft 4123. One end of the locking wrench 4121 is equipped with an eccentric rotating part 4124. The eccentric rotating part 4124 is rotatably connected to the first mounting sleeve 411 via the rotating shaft 4123. One end of the connecting rod 4122 is connected to the eccentric rotating part 4124, and the other end is connected to the pressing member 413. This configuration enables the eccentric rotating part 4124 to drive the first adjusting member 414, the second adjusting member 415, and the pressing member 413 to move. In the present disclosure, the locking wrench 4121 drives the eccentric rotating part 4124 to move. When the eccentric rotating part 4124 moves toward the first mounting sleeve 411, it pulls the pressing member 413 toward the first mounting sleeve 411 via the connecting rod 4122 due to the axial fixation between the rotating shaft 4123 and the first mounting sleeve 411. The pressing member 413 then locks the first section 1 and the second section 2. Simultaneously, the eccentric rotating part 4124 pushes the first adjusting member 414 and the second adjusting member 415 to move, triggering the second locking assembly 43 to lock the third section 3, thereby locking the entire tripod. When the eccentric rotating part 4124 moves away from the first mounting sleeve 411, it pushes the pressing member 413 away from the first mounting sleeve 411 via the connecting rod 4122 due to the axial fixation between the rotating shaft 4123 and the first mounting sleeve 411, releasing the first section 1 and the second section 2. At this point, the eccentric rotating part 4124 disengages from the first adjusting member 414, and the first adjusting member 414, the second adjusting member 415, and the third adjusting member 416 reset. The second locking assembly 43 releases the third section 3, thereby releasing the entire tripod.

Furthermore, as shown in FIG. 5, a locking sleeve 44 is provided at the end of the first section 1. The first mounting sleeve 411 features a movable shaft hole 4111 and a fixed shaft hole 4112. The locking sleeve 44 movably extends through the movable shaft hole 4111, and the end of the second section 2 is fixed within the fixed shaft hole 4112. Notch grooves 4113 (e.g., slotted notches) are present on the sides of the movable shaft hole 4111 and the fixed shaft hole 4112. The pressing member 413 extends through the notch grooves 4113 to engage with or disengage from the locking sleeve 44 and the second section 2. In this disclosure, when the pressing member 413 disengages from the locking sleeve 44, the first section 1 can move relative to the first mounting sleeve 411. The second section 2 and the third section 3 can move downward under the action of the first mounting sleeve 411, enabling the first stage of extension/retraction.

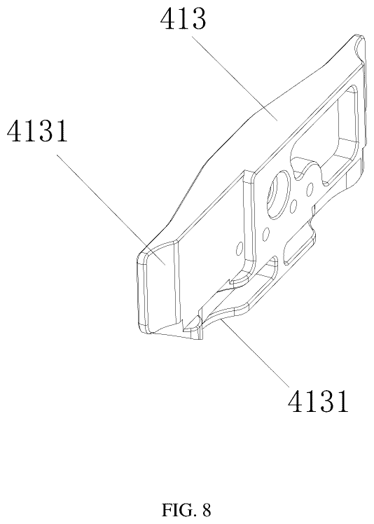

Furthermore, as shown in FIG. 8, the pressing member 413 features a pressing groove 4131 for pressing and securing the first section 1 and the second section 2.

Furthermore, the first adjusting member 414 and the second adjusting member 415 are equipped with clearance holes through which the connecting rod 4122 movably extends. This design improves the structural coupling among the first adjusting member 414, the second adjusting member 415, the pressing member 413, and the locking portion, saves space, and reduces the product size.

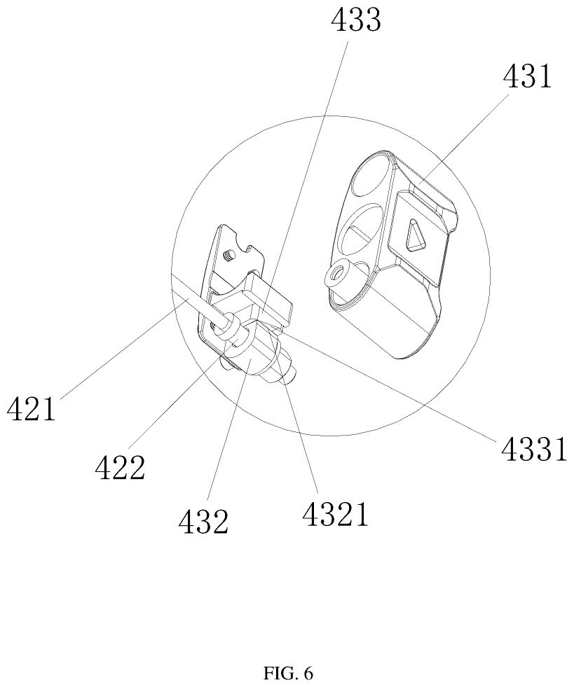

Furthermore, as shown in FIG. 6, the second locking assembly 43 includes a second mounting sleeve 431, a fourth adjusting member 432, and a fifth adjusting member 433. The second mounting sleeve 431 is fixed to the end of the second section 2 opposite to the first locking assembly 41, and the third section 3 is movably connected to the second mounting sleeve 431. The fourth adjusting member 432 and the fifth adjusting member 433 are movably disposed within the second mounting sleeve 431. The fourth adjusting member 432 is connected to the end of the connecting assembly 42 opposite to the first locking assembly 41. The first locking assembly 41 can drive the connecting assembly 42 to move, causing the fourth adjusting member 432 to engage with the fifth adjusting member 433, thereby enabling the fifth adjusting member 433 to lock or release the third section 3. In this disclosure, when the connecting assembly 42 moves under the action of the third adjusting member 416, it drives the fourth adjusting member 432 and the fifth adjusting member 433 to move. The fifth adjusting member 433 presses against or moves away from the third section 3, thereby locking or releasing the third section 3. When released, the second stage of extension/retraction can be performed.

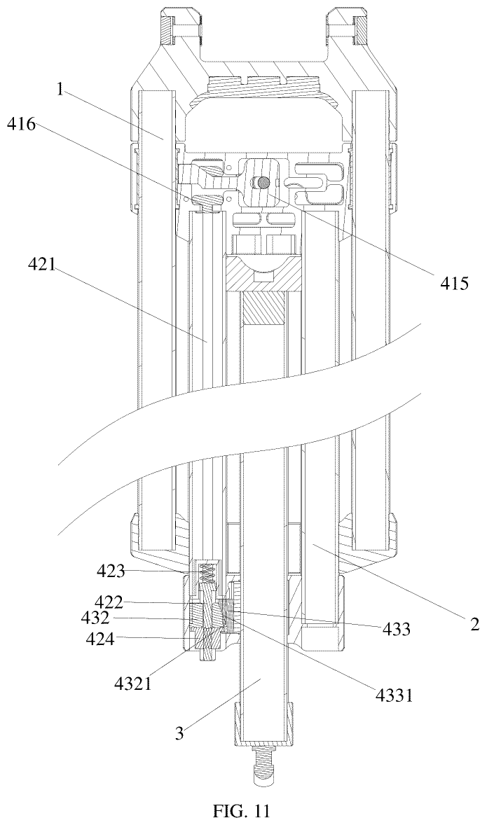

Furthermore, as shown in FIGS. 6 and 11, the fourth adjusting member 432 features a fifth inclined surface 4321, and the fifth adjusting member 433 features a sixth inclined surface 4331. The fourth adjusting member 432 can cooperate with the fifth inclined surface 4321 and the sixth inclined surface 4331 to drive the fifth adjusting member 433 to lock or release the third section 3.

Furthermore, as shown in FIGS. 6 and 11, the connecting assembly 42 includes a connector 421, a movable rod 422, and a nut 424. The connector 421 extends through the second section 2, with one end connected to the first locking assembly 41 and the other end connected to the movable rod 422. The movable rod 422 is connected to the fourth adjusting member 432. The fourth regulating part 432 is sleeved outside the movable rod 422, and the nut 424 is connected to the movable rod 422. The fourth regulating part 432 is provided between the movable rod 422 and the nut 424. When the third adjusting member 416 pulls the connector 421 upward, it pulls the fourth adjusting member 432 upward via the movable rod 422. The fourth adjusting member 432 then pushes the fifth adjusting member 433 to the right through the inclined surfaces, locking the third section 3. Consequently, the first locking assembly 41 and the second locking assembly 43 are locked synchronously.

Furthermore, as shown in FIG. 11, the connecting assembly 42 further includes a connecting return spring 423. One end of the connecting return spring 423 is in contact with or connected to the movable rod 422, and the other end is in contact with or connected to the second mounting sleeve 431. When the locking part of the first locking assembly 41 is released, the tensile force exerted by the third adjusting member 416 on the connector 421 disappears. At this point, the connecting return spring 423 can push the fourth adjusting member 432 downward, and the fifth adjusting member 433 simultaneously releases the third section 3, thereby achieving synchronous releasing of the first locking assembly 41 and the second locking assembly 43.

Furthermore, the connector 421 is a screw rod.

As used in the claims, the indefinite articles “a” and “an” should be understood to mean “one or more” unless explicitly stated otherwise or unless the context clearly dictates a singular interpretation. The use of these articles does not limit the claimed invention to a single instance of the referenced element but rather encompasses multiple instances where applicable.

As used herein, the terms “member” and “part” each refer to a tangible, physical structure, such as a component, element, or part, which may be formed from any suitable material. Unless explicitly stated otherwise, the use of the term “member” or “part” is not intended to invoke 35 U.S.C. § 112(f), and should not be construed as a means-plus-function limitation.

What is claimed is:

1. A lifting tripod, comprising:
a first section;
a second section movably connected to the first section;
a third section movably connected to the second section;
a locking mechanism operable to lock the first section, the second section, and the third section;
the locking mechanism further operable to release the first section, the second section, and the third section;
the locking mechanism comprising a first locking assembly, a connecting assembly, and a second locking assembly;
the first locking assembly is provided at a top of the second section and the second locking assembly is provided at a bottom of the second section; and
the first locking assembly and the second locking assembly are connected via the connecting assembly.

2. The lifting tripod according to claim 1, wherein the first locking assembly comprises a first mounting sleeve, a locking member, and a pressing member;
wherein the first mounting sleeve is provided at the top of the second section, and the first section is provided within the first mounting sleeve;
wherein the locking member and the pressing member are connected; and
in response to an actuation of the locking member, the pressing member is configured to move away from the first mounting sleeve to release the first section, or move toward the first mounting sleeve to lock the first section.

3. The lifting tripod according to claim 2, wherein the first locking assembly further comprises a first regulating part, a second regulating part, and a third regulating part;
wherein the locking member comprises a locking wrench and a connecting rod;
wherein the first regulating part and the second regulating part are movably disposed on the connecting rod;
wherein a first end of the second regulating part cooperates with the first regulating part, and a second end of the second regulating part cooperates with the third regulating part;
wherein the third regulating part is connected to the connecting assembly; and
in response to an actuation of the locking wrench, the first regulating part is configured to drive movement of the second regulating part and the third regulating part, thereby enabling the connecting assembly to move and drive the second locking assembly to lock or release the third section.

4. The lifting tripod according to claim 3, wherein the first regulating part comprises a first inclined surface, a first end of the second regulating part comprises a second inclined surface cooperating with the first inclined surface, and a second end of the second regulating part comprises a third inclined surface;
wherein the third regulating part comprises a fourth inclined surface cooperating with the third inclined surface; and
wherein the first inclined surface cooperates with the second inclined surface to drive the second regulating part to move lengthwise along the first mounting sleeve, thereby engaging the third inclined surface with the fourth inclined surface of the third regulating part, driving the connecting assembly to move heightwise along the second section, further driving the second locking assembly to lock or release the third section.

5. The lifting tripod according to claim 4, wherein the first inclined surface, the second inclined surface, the third inclined surface, and the fourth inclined surface are all inclined lengthwise along the second regulating part.

6. The lifting tripod according to claim 4, wherein the third regulating part comprises a first connecting part and a second connecting part;
wherein a movable groove is formed between the first connecting part and the second connecting part;
wherein one end of the second regulating part with the third inclined surface is movably disposed in the movable groove; and
wherein the fourth inclined surface is disposed on a side wall of the first connecting part facing the movable groove, and the second connecting part is connected to the connecting assembly.

7. The lifting tripod according to claim 3, wherein the locking member further comprises a rotating shaft;
wherein one end of the locking wrench is provided with an eccentric rotating part;
and
wherein a first end of the connecting rod is connected to the eccentric rotating part via the rotating shaft, and a second end of the connecting rod is connected to the pressing member, enabling the eccentric rotating part to drive the first regulating part, the second regulating part, and the pressing member to move.

8. The lifting tripod according to claim 1, wherein the second locking assembly comprises a second mounting sleeve, a fourth regulating part, and a fifth regulating part;
wherein the second mounting sleeve is connected to one end of the second section away from the first locking assembly;
wherein the third section is movably connected to the second mounting sleeve;
wherein the fourth regulating part and the fifth regulating part are provided in the second mounting sleeve;
wherein the fourth regulating part is connected to one end of the connecting assembly away from the first locking assembly; and
wherein the first locking assembly is configured to drive the connecting assembly to move, thereby engaging the fourth regulating part with the fifth regulating part, enabling the fifth regulating part to lock or release the third section.

9. The lifting tripod according to claim 8, wherein the fourth regulating part is provided with a fifth inclined surface, and the fifth regulating part is provided with a sixth inclined surface; and
wherein the fourth regulating part is configured to cooperate with the sixth inclined surface through the fifth inclined surface to drive the fifth regulating part to lock or release the third section.

10. The lifting tripod according to claim 9, wherein the connecting assembly comprises a connector, a movable rod, and a nut;
wherein the connector passes through the second section, with a first end of the connector connected to the first locking assembly and a second end of the connector connected to the movable rod; and
wherein the fourth regulating part is sleeved outside the movable rod, the nut is connected to the movable rod, and the fourth regulating part is provided between the movable rod and the nut.

11. The lifting tripod according to claim 10, wherein the connecting assembly further comprises a connecting return spring; and
wherein a first end of the connecting return spring abuts against or is connected to the movable rod, and a second end of the connecting return spring abuts against or is connected to the second mounting sleeve.
